(19) United States
(12) Patent Application Publication
(10) Pub. No.: US 2016/0047405 A1
(43) Pub. Date: Feb. 18, 2016

(54) Collapsible Exercise Bar

(71) Applicant: Kevin Curley, Acton, MA (US)

(72) Inventor: Kevin Curley, Acton, MA (US)

(21) Appl. No.: 14/460,318

(22) Filed: Aug. 14, 2014

(51) Int. Cl. F16B 7/10; A63B 21/06; F16B 47/00; F16M 11/24; A47B 81/00; A63B 21/00; A63B 21/055

(52) U.S. Cl. CPC F16B 7/10; A63B 21/1469; A63B 21/06; A63B 21/055; F16M 11/24; A47B 81/005; F16B 47/00

(57) ABSTRACT

The present disclosure relates to telescoping exercise bars which are configured to allow attachments to be affixed at one or both of the ends of the bars or along the bar at desired positions.

### FIELD OF THE INVENTION

The present disclosure relates to the field of exercise equipment. More particularly the present disclosure relates to telescoping exercise bars which are configured to allow attachments to be affixed at one or both of the ends of the bars or along the bar at desired positions.

### BACKGROUND OF THE INVENTION

Exercise bars are commonly used in exercise environments such as gymnasiums, physical therapy rooms, training rooms and exercise rooms. They can be used for general stretching and limbering up, or they can be used prior to physical exertion such as organized sports such as football, basketball, hockey and the like as well as individual sports such as golf, tennis and running. These devices are generally curt from PVC tubes and can have sharp edges and are less than attractive pieces of exercise equipment. Current exercise bars made from PVC tubing cannot be reduced in size for ease of portability and are cumbersome. Telescoping exercise bars have been disclosed but are one dimensional in that they are limited in their ability to accommodate users of different abilities, different strengths, different heights and weights and different objectives in their exercise curriculum. For example a standard telescoping bar can be shortened or lengthened to fit a user's physical make-up, but the bar cannot be adapted to add weight for increased resistance in the exercise movement or provide stability when used in a vertical position. Thus there is a need for an exercise bar that is collapsible for ease of storage and ease of portability while at the same time providing increased capabilities to provide more exercise functions.

### BRIEF DESCRIPTION OF THE DRAWINGS

FIG. 1 illustrates the exercise bar of the current disclosure in its extended configuration.

FIG. 2 illustrates the exercise bar along with the eccentric cam mechanism in its closed, retracted position.

FIG. 3 illustrates an end of the telescoping member 30 in which an opening 32 is configured which allows an attachment to be added.

FIG. 4 illustrates the end of the exercise bar 40 with a suction cup 42 attached by sliding the cup onto the end on the telescoping member.

FIG. 5 illustrates the exercise bar configured with a foot stand 50 and a gun cradle 52.

### SUMMARY OF THE INVENTION

Disclosed and claimed herein are collapsible, telescoping exercise bars which are configured with the ability to affix a variety of functionalities to the ends of the bar or any other position along the bar as desired.

In a first embodiment disclosed and claimed herein is an exercise bar comprising a) a main bar, b) at least two telescoping members which can slide along the main bar and can be coupled in position to the main bar, but can be decoupled and moved to other positions along the main bar as desired, with each member having an outer end, and c) a means for adding at least one attachment, wherein the telescoping members extend and retract relative to the main member as desired with minimal resistance.

In a second embodiment disclosed and claimed herein is the exercise of the above embodiment, wherein the means for adding an attachment is positioned into the outer end of the telescoping member.

In a third embodiment disclosed and claimed herein are the exercise bars of the above embodiments, wherein the means for adding an attachment is positioned at least along the main bar or along the telescoping member.

In a fourth embodiment disclosed and claimed herein are the exercise bars of the above embodiments wherein the attachments include handgrips, weights, suction cups, non-slip end pieces, tethers, ropes, cords, stretch bands and measuring devices.

In a fifth embodiment disclosed and claimed herein are the exercise bars of the above embodiments, wherein the telescoping members are slideably coupled by at least one of an eccentric cam mechanisms, snap buttons, thumb locking collars, screw heads, threaded connections or twist snap in socket mechanisms.

The exercise bar of the current disclosure is configured to be collapsible and readily portable by hand or configured to fit in a handbag, duffle bag, gym bar or other carrying device.

In other embodiments disclosed and claimed herein are the bars of the above embodiments wherein the attachments are configured for non-exercise applications such as, for example, foot attachments for standing the bar on one end, a gun cradle attachment for steadying a gun, a camera attachment for positioning a camera, or a binocular or scope attachment for steadying a scope or binoculars.

### DETAILED DESCRIPTION OF THE INVENTION

Disclosed and claimed herein are collapsible, telescoping exercise bars which are configured with the ability to affix a variety of functionalities to the ends of the bar or any other position along the bar as desired.

The telescoping members are slideably coupled to the main member, and, in the case where there are more than one pair of telescoping members, to a second pair of telescoping members. The phrase “slideably coupled” as used herein refers to the process of sliding the member over or into the main bar and coupling the main bar and the telescoping member together so that no sliding will occur during exercise. The coupling is not permanent in that it can be decoupled and moved to different positions as desired, including completely retracted to its shortest length. The phrase “outer end” refers to the end of the end of the telescoping member which is at the one or the other ends of the exercise bar either retracted or extended.

In one embodiment an eccentric cam mechanism is used to couple and temporarily lock the members in place. Examples of eccentric cam mechanisms as used in telescoping and temporarily locking is described in U.S. Pat. No. 4,464,078 to Vorobyov, incorporated herein by reference for the eccentric cam lock mechanisms for telescoping and temporarily locking disclosed therein. Using eccentric cam systems, the length of the exercise bar can be infinitely adjusted, limited only by the full extension of the telescoping members and complete retraction of the members.

In other embodiments temporary locking pins, such as, for example, snap buttons which lock the telescoping member in place when pins on the main bar align with holes on the telescoping member can be used. The length of the exercise bar is configured in discrete steps governed by the position of the holes in the member and the distance between them.

For example, the telescoping member telescopes to a certain length and is retained in an extended position by a snap button which may be made of metal. The snap buttons have both a button leg with a button head and a spring leg. The button leg may also be a spring type of leg. In an exemplary embodiment the snap button is compressed, the telescoping member is moved and the snap buttons are released, or snap back to their uncompressed state through holes located in either the main bar or other telescoping members to lock the member sections in place.

Other devices may also be used to extend and retract the members including, for example, thumb locking collars, screw heads, twist snap in sockets and the like. It should be noted that more than one pair is telescoping members may be used in the currently disclosed application for patent so that the exercise bar may be retracted to a small configuration or extended to a longer configuration than with only one pair. The sections of the exercise bar may include bushings or other mechanisms which are designed to stop the telescoping members from detaching completely from the main bar when the members are fully extended, so that the exercise bar is generally of a single unit construction.

In some embodiments the attachments may be position into the ends of the telescoping members. In these embodiments the attachments may be attached by, for example threading into the ends, clipping into the ends, pressure fitting into the ends, hanging off the ends, slip fit and other attachments means. In these embodiments the ends of the telescoping member are configured to receive the attachments by such means as threading, such as screwing, openings for clipping, openings for pressure fitting, hooking devices for hanging attachments, slip fit mechanisms and the like.

In other embodiments the attachments may be positioned toward the ends of the telescoping members but not into the ends as in the above embodiment depending on the exercise desired. The telescoping members may be configured with grooves, snaps, hooks, holes or other devices that allow an attachment to be added.

In other embodiments the attachments may be positioned further inward from the ends toward the center of the bar. The telescoping members may be configured with grooves, snaps, hooks, holes or other devices that allow an attachment to be added, for such as, for example, a tether with weights attached for wrist rolls or bicep curls.

The attachments include for example hand grips wherein the grip is made of non-slip materials such as, for example, tacky polymers as are used in golf club grips to prevent slippage of the hand during exercise, or the grips may be configured for comfort, made from materials which allow a cushioning effect for the hands. The hand grips may be attached to the telescoping member by threading them into the ends of the member or tightly slipping them over the telescoping member. They can be tight fit so that they do not slip off the telescoping member or they can be removably attached by a hand screws, pressure clips, snap buttons or the like.

Other attachments include weights which can be attached into the ends of the telescoping members by screwing them into the member tightly slipping them over the telescoping member as described above. The weights may also hang from tethers, such as ropes, cords, bands, and the like, attached to any section of the exercise bar from the very end to the middle allowing a number of other exercises to be performed such as bicep curls, wrist exercises, bench presses, military lifts, squat bends, any other exercise associated with weights. The currently disclosed exercise bar allows for low weight attachments which are not found in weight exercise equipment, such as weights measured in ounces as opposed to 5-10 pound increments.

Other attachments can include suction cups or other gripping attachments such as non-slip end caps which can be attached by any of the methods described above. These attachments are designed so that when the exercise bar is positioned on a surface in a vertical position, the attachment on the end of the telescoping member will retard slipping so that the person exercising will not slip as well and become injured.

Other attachments may include stretch bands which may be used to attached the bar to a stationary object and create increasing resistance as the bar and the stretch bands are stretched during an exercise.

Other attachments may include measuring devise, such as, for example, to measure the speed of a swing when the bar is used to mimic a baseball swing or a golf swing.

In operation the telescoping member ready and easily slides over the main bar, or other telescoping members, if present, and when the desired length is reached the eccentric cam mechanism is turned and the member or members are locked in place until such as time as retraction is desired, then the eccentric cam is turned in the opposite direction freeing the telescoping member and retracting it to a shorter configuration where the cam is again turned to secure the member in a retracted position. The same operation is used with the other locking mechanisms, for example, when the exercise bar is equipped with snap buttons, the member slides to the pre-designed hole and snaps into place.

The exercise bar may have an overall cross section that is circular, ovate or other shape as desired for exercise.

The exercise bar and its components may be made from any durable material, including, for example, aluminum, plastic, composite materials such as Kevlar or fiberglass, or other materials which provide strength.

In other embodiments disclosed and claimed herein are the bars of the above embodiments wherein the attachments are configured for non-exercise applications such as, for example, foot attachments for standing the bar on one end, a gun cradle attachment for steadying a gun, a camera attachment for positioning a camera, or a binocular or scope attachment for steadying a scope or binoculars.

Turning to the figures: FIG. 1 illustrates the exercise bar 1 in its extended configuration. The telescoping members 10 are locked into place on the main bar 12 by eccentric cam mechanisms 14. Also show is one embodiment in which hand grips 16 are attached onto the ends of the telescoping members. Also show are optional grooves on the telescoping member 18 and on the main bar 20 for securing other optional attachments. Also shown are holes 22 for attachments that are secured with screws, pins, snap buttons or other optional attachment mechanism. Also shown are bushings 24 that prevent the telescoping members from separating from the main bar.

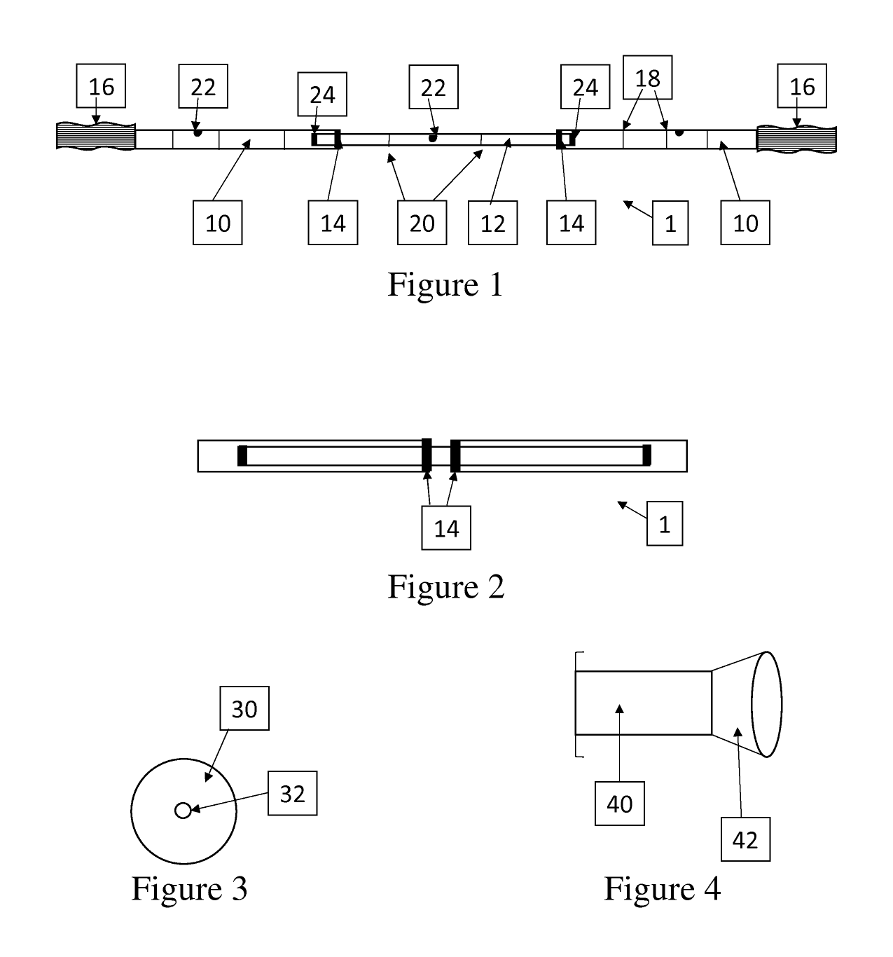

FIG. 2 illustrates the exercise bar 1 along with the eccentric cam mechanism 14 in its closed, retracted position suitable now for storage in a small compartment such as a gym bag or other carrying device.

FIG. 3 illustrates an end of the telescoping member 30 in which an opening 32 is configured which allows an attachment to be added. For example the opening is threaded if the attachment to be added has a threaded screw attached to the attachment.

FIG. 4 illustrates the end of the exercise bar 40 with a suction cup 42 attached by sliding the cup onto the end on the telescoping member.

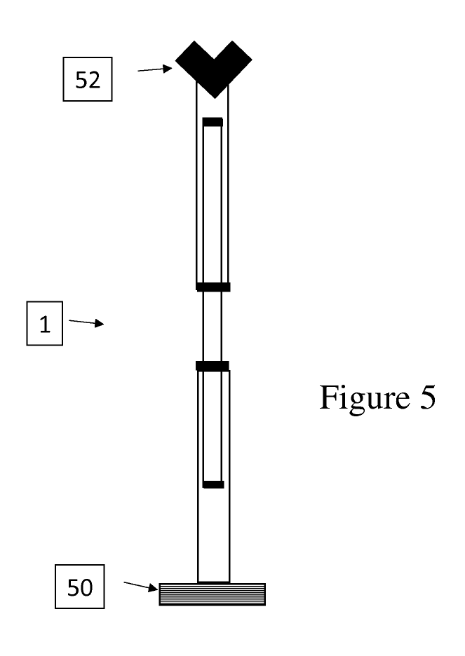

FIG. 5 illustrates the exercise bar configured with a foot stand attachment 50 and a gun cradle attachment 52.

What is claimed is:

1. An exercise bar comprising:
a. A main bar,
b. At least two telescoping members slideably and movably coupled to the main bar, each having an outer end, and
c. A means for adding at least one attachment,
wherein the telescoping members extend and retract relative to the main member with minimal resistance.

2. The exercise bar of claim 1, wherein the means for adding an attachment is positioned into the outer end of the telescoping member.

3. The exercise bar of claim 1, wherein the means for adding an attachment is positioned at least along the main bar or along the telescoping member.

4. The exercise bar of claim 1, wherein the attachments are chosen from handgrips, weights, suction cups, non-slip end pieces, tethers, ropes, cords, stretch bands and measuring devices.

5. The exercise bar of claim 1, wherein the telescoping members are slideably coupled by at least one of an eccentric cam mechanisms, snap buttons, thumb locking collars, screw heads, threaded connections or twist snap in socket mechanisms.

6. The exercise bar of claim 1, wherein the attachments are chosen for non-exercise applications.

7. The exercise bar of claim 6, wherein the attachments are chosen from at least one of a foot stand, a gun cradle, a camera fixture device, a scope stability device or a binocular stability device.
